(19) United States
(12) Patent Application Publication
(10) Pub. No.: US 2008/0299306 A1
(43) Pub. Date: Dec. 4, 2008

(54) Multi-layer substrate and method of fabrication

(75) Inventors: Ashwin A. Hattiangadi, Dunlap, IL (US); Robert Howard Hartseil, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/806,169

(22) Filed: May 30, 2007

(51) Int. Cl. B05D 3/02; B32B 15/00

(52) U.S. Cl. 427/228; 428/615

(57) ABSTRACT

A method for coating a substrate is disclosed. The method includes applying a coating to a surface of the substrate and heating the applied coating and the substrate to a temperature less then approximately 600° C. to create a tempered zone within the substrate. The method further includes cooling the applied coating and the substrate.

### TECHNICAL FIELD

The present disclosure relates to a substrate and method of fabrication and, more particularly, to a multilayer substrate and a method for fabricating the substrate.

### BACKGROUND

Components that are exposed to corrosive or high wear environments usually include a base material and a coating layer applied thereon. The coating layer may include properties or characteristics that are relatively more resistive to corrosion or wear than the base material, and the base material may include properties that are relatively stronger or more durable than the coating layer. The coating layer is usually applied to the base material by a coating process such as, for example, high velocity oxygen fuel (“HVOF”) process. An HVOF process usually includes spraying a stream of high velocity exhaust from an oxygen-fuel torch and injecting powered metal into the exhaust that subsequently melts. The exhaust-powered metal mixture is directed toward the base material, impinges the base material, and forms a mechanical bond as it cools. Although suitable for some applications, the mechanically bonded coating layer often exhibits an undesirably short lifecycle under heavy loading because of cracking, spalling and/or other failure.

U.S. Pat. No. 6,083,330 (“the '330 patent”) issued to Moskowitz discloses an improved process for metallurgically bonding a coating to a substrate. The process of the '330 patent includes cleaning a substrate, applying a coating on the substrate with a HVOF thermal spray process and subjecting the coated substrate to a stepped heat treatment over a period of several hours. During the stepped heat treatment, the coated substrate is subjected to three required heating steps and an optional fourth step at temperatures of 500° F., 1000° F., 1220° F., and 1400° F. respectively. The substrate is heated from a previous temperature to a new temperature over a 30 minute period and held at the new temperature for an additional 30 minutes. The coated substrate is also subjected to a post heat treatment between a minimum temperature of 1400° F. and a maximum temperature of slightly less than the melting point of the coating for a time period of 0.5 to 24 hours. The process of the '330 patent utilizes a furnace to heat the coated substrate during each of the heat treatment steps and the post heat treatment.

Although the process of the '330 patent may result in a coated substrate having improved properties, the properties and characteristics of the substrate and adjacent components may be undesirably altered because the substrate is subjected to the elevated temperatures. Additionally, the time required to heat treat the coated substrate in the process of the '330 patent may be significant, resulting in increased manufacturing time and costs.

The present disclosure is directed to overcoming one or more of the shortcomings set forth above.

### SUMMARY OF THE INVENTION

In one aspect, the present disclosure is directed to a method for coating a substrate. The method includes applying a first coating to a surface of the substrate and heating the applied first coating and the substrate to a temperature less than approximately 600° C. to form a tempered zone within the substrate. The method further includes cooling the applied first coating and the substrate.

In yet another aspect, the present disclosure is directed to a coated substrate. The substrate is formed from a metallic material. The coated substrate also includes a coating mechanically bonded to the substrate. The coated substrate further includes a tempered zone between the substrate and coating, formed by heating the substrate and the coating to a temperature less than approximately 600° C.

### BRIEF DESCRIPTION OF THE DRAWINGS

FIG. 1 is a cross-sectional illustration of a coated substrate; and

FIG. 2 is a flow chart of an exemplary method for fabricating the coated substrate shown in FIG. 1.

### DETAILED DESCRIPTION

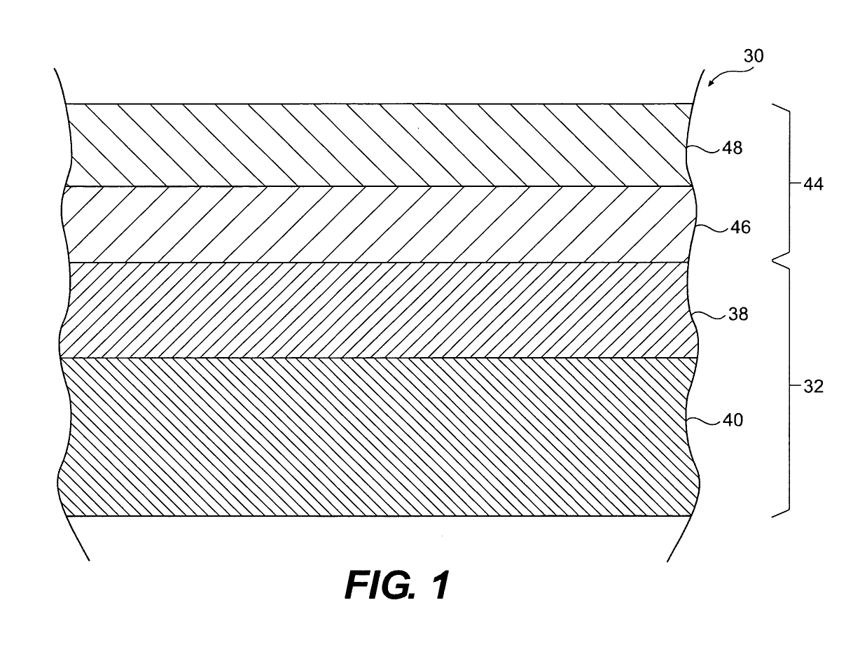

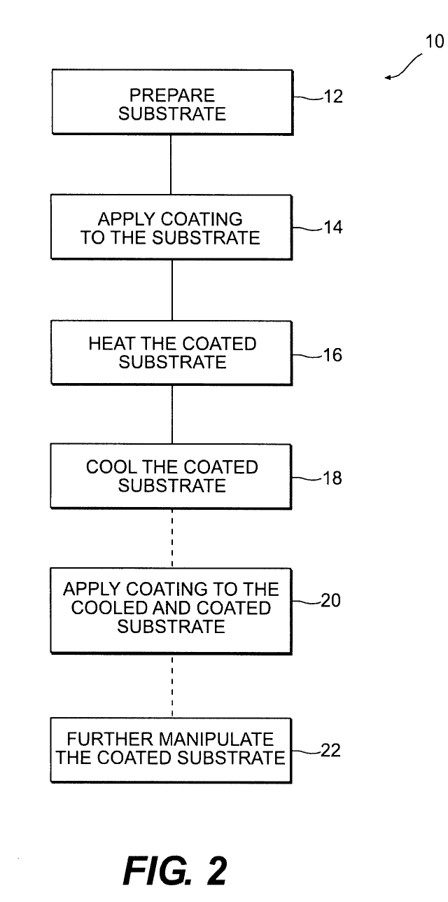

FIG. 1 illustrates an exemplary cross-sectional segment of a coated substrate 30 provided by performing one or more steps of method 10 (referring to FIG. 2). Coated substrate 30 may include a substrate 32 and a coating 44. Substrate 32 may include any object, part, or component formed from any metallic-based material. For example, substrate 32 may embody a bushing, pin or hydraulic cylinder. Furthermore, substrate 32 may include a soft or tempered zone 38 and a harder or un-tempered zone 40. Zones 38 and 40 may be the result of a heat treatment process of method 10.

Coating 44 may include a metallic, a cermet and/or any other metallic-based material known in the art and may be an HVOF applied coating or a spray-form coating. The motivations to apply a coating to a substrate are well known in the art and include, for example, providing a coating material that is relatively more resistive to wear and/or corrosion than the substrate material. It is also contemplated that, if used, the cermet material may include any percentage of metal and ceramic materials, such as for example, a form chromium carbide (Cr₃C₂, Cr₂₃C₆, or Cr₇C₃). Coating 44 may or may not include multiple layers 46 and 48 and these layers may or may not be composed of the same material. Coating 44 may, for example, have a thickness of 50-350 μm.

FIG. 2 illustrates an exemplary method of fabricating coated substrate 30. FIG. 2 will be discussed in detail in the following section.

### INDUSTRIAL APPLICABILITY

The disclosed metallic substrate may exhibit superior bond strength and, as a result, be less likely to fail due to delamination. A tempered zone underneath an outer coating of the disclosed substrate allows for increased stress absorption capacity and decreased residual stress within the substrate and coating, resulting in increased the bond strength. A method of fabricating the disclosed substrate is explained below.

FIG. 2 illustrates an exemplary method 10 for applying a coating. Method 10 may be applicable to a component or part of an assembly such as, for example, a bushing, pin, hydraulic cylinder or undercarriage that may be exposed to a relatively high wear and/or highly corrosive environment and may require given material properties to resist deterioration within such an environment. Forming the entire component or part from material having the given material properties may be undesirably expensive and/or may undesirably sacrifice other desirable properties, e.g., strength or fatigue resistance, to establish the wear or corrosive resistant properties. As such, coating a substrate formed from a first material and applying a coating of a second material may provide a component having substantially all of the desired properties.

The first step of this method may include preparing a substrate 32 (step 12). Specifically, preparing may include roughening the surface of substrate 32 by, for example, grit blasting substrate 32 and cleaning the surface of substrate 32 to remove oxides, grease, carburization and/or other contaminants. It is contemplated that the step of roughening the surface of substrate 32 may be omitted, if desired.

After substrate 32 has been prepared, a high velocity oxygen fuel (“HVOF”) coating 46 may be applied to the surface of substrate 32 (step 14). HVOF coating processes are well known in the art and may include mixing oxygen and a fuel within a torch apparatus, and directing the combustion exhaust thereof through a nozzle toward substrate 32. HVOF coating processes may also include delivering a metal powder such as chromium carbide into the exhaust stream. Each particle of the metal powder may increase in temperature, become molten, and accelerate when exposed to the exhaust stream. HVOF coating processes may also include directing the combined stream of exhaust and metal powder toward substrate 32 wherein the molten particles may impact the surface of substrate 32, build-up, and overlap one another to substantially coat the surface of substrate 32, (i.e., form a coating 46 on the surface of substrate 32). HVOF coating processes may further include allowing the molten build-up of metal powder to cool and form a mechanical bond with the surface of substrate 32.

After substrate 32 has been coated, coated substrate 30 may be heated via a furnace heating method (step 16). Specifically, in order to reduce the risk of thermal shock, coated substrate 30 may be placed in a cool furnace and heated at a predetermined rate to a specified temperature, for example coated substrate 30 may be heated to about 450° C. at a rate of about 15° C. per minute. The temperature to which substrate 32 and coating 46 are heated may be greater than the Martensite Start temperature (Ms) of the substrate material and less than about 600° C. By heating to a temperature within this range, tempering of substrate 32 may occur without risk of undesirable metallurgical changes within substrate 32 and coating 46 and/or adjacent components (not shown) that may occur at higher temperatures. The maximum temperature may be held for a predetermined period, for example about two hours. During the heat treatment, internal stresses within substrate 32 and coating 46 may be relieved and the tempering may result in a soft or tempered zone 38 within substrate 32, underneath the coating 46. Tempered zone 38 may allow for increased stress absorption capacity and decreased residual stress at the interface between the coating 46 and substrate 32. For example, following heat treatment, substrate 32 may exhibit an increase in fatigue life under compression loading of at least 300%. Furthermore, it is contemplated that during the heat treatment, new metallurgical phases that are different from the original state of substrate 32 and coating 46 may be introduced.

Alternatively, substrate 32 and coating 46 may be heated via an induction heating method. An induction heating method may include subjecting coated substrate 30 to an electromagnetic field to vibrate the electrons within substrate 32 and coating 46. The electromagnetic field may be established by passing an electric current through an electromagnetic coil, and vibration of the electrons may increase the temperature of substrate 32 and coating 46. During the induction heating process, the substrate may be heated at a rate that is less than about 200° C./sec and the region of contact between substrate 32 and coating 46 may reach a temperature of approximately 350-570° C.

Following the furnace or induction heating of coated substrate 30, coated substrate 30 may be cooled (step 18). In order to reduce the risk of thermal shock and the introduction of new thermal stresses, coated substrate 30 may include subjecting coated substrate 30 to ambient air. Cooling coated substrate 30 may include establishing the material properties, e.g., hardness, within the coated and heated portion of substrate 32. For example, the given material properties of substrate 32 may change during heating as a function of the increased temperature affecting the molecular structure of substrate 32. For example, heating coated substrate 30 may result in substrate 32 changing from a pre-heating phase structure to a martinsitic phase structure. As such, controlled cooling may reestablish the pre-heating phase structure of coated substrate 30. It is further contemplated that localized areas of coated substrate 30 may be cooled at different rates in order to achieve varying material properties across different regions of substrate 32.

After coated substrate 30 has been cooled, an additional coating layer 48 may be applied thereto (step 20). Specifically, a coating 48 that includes a metallic material, a cermet material and/or any other metallic-based material known in the art may be applied to the cooled and coated substrate via any coating process, such as, for example an HVOF coating process. The material of this additional coating layer 48 may or may not be the same as those of the initial coating layer 46 and/or may be applied in a different manner. It is contemplated that the additional coating layer 48 may be omitted, if desired. If additional layer 48 is omitted, the entire desired thickness of the coating layer 44 may be applied during step 14. If two layers 46 and 48 of coating are applied to substrate 32, the thickness of the initial coating layer 46 may be less than the desired total coating layer 44 thickness, and the combined thickness of the initial coating layer 46 and the additional coating layer 48 may establish the desired coating layer 44 thickness. It is also contemplated that the surface of the coating layer 46 may be cleaned to remove oxides, grease, carburization and/or other contaminants before application of the additional coating layer 48. It is further contemplated that the additional coating layer 48 may not be locally heated and cooled and thus may not have its material properties affected by such processes.

Once both coating layers 46 and 48 have been applied to substrate 32, method 10 may include further manipulating coated substrate 30 (step 22). This manipulation step may include machining, polishing, and/or other machining processes known in the art. It is contemplated that this manipulation step may establish predetermined and/or desired dimensions of coated substrate 30 and/or thickness of the coating. It is also contemplated that this step may selectively be omitted from method 10.

Several advantages may be associated with the disclosed method of coating a substrate. Specifically, the disclosed method may use a relatively low temperature heat treatment to create a tempered zone that allows for increased stress absorption capacity at the interface between the coating and substrate. As a result, the disclosed method may increase the bond strength of the coating without compromising desirable material properties throughout the substrate or adjacent components. Furthermore, the disclosed method achieves these results without undesirably long and costly heating processes.

It will be apparent to those skilled in the art that various modifications and variations can be made to the disclosed method for coating a substrate. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A method for coating a substrate comprising:
applying a first coating to a surface of the substrate;
heating the first coating and the substrate to a temperature less than approximately 600° C. to form a tempered zone within the substrate; and
cooling the first coating and the substrate.

2. The method of claim 1, wherein applying a coating includes applying a metallic or cermet coating via a high velocity oxygen fuel coating process.

3. The method of claim 1, further including cleaning the surface before applying the coating to the surface.

4. The method of claim 1, wherein:
heating and cooling the substrate of the substrate establishes first and second zones within the substrate;
the first zone is disposed between the first coating and the second zone; and
a hardness of the first zone is less than a hardness of the first coating and a hardness of the second zone.

5. The method of claim 1, wherein heating includes heating the substrate and coating via a furnace heating process.

6. The method of claim 5, wherein heating includes heating to approximately 450° C. and maintaining for approximately two hours.

7. The method of claim 5, wherein heating includes heating at a rate of less than approximately 15° C. per minute.

8. The method of claim 1, wherein cooling includes subjecting the first coating to ambient air.

9. The method of claim 1, further including applying a second coating to a surface of the first coating.

10. The method of claim 1, wherein heating includes heating the substrate and first coating via an induction heating process, wherein an area of contact between the substrate and first coating is heated to approximately 350-570° C.

11. The method of claim 1, wherein heating includes heating the substrate and first coating to a temperature greater than the Martensite start temperature of the substrate.

12. The method of claim 1, wherein coating includes coating with chromium carbide.

13. The method of claim 1, wherein the heating creates a material phase structure within the substrate that is dissimilar to an original state of the substrate.

14. The method of claim 11, further including machining or polishing the substrate after cooling the applied first coating and the substrate.

15. A coated substrate comprising:
a metallic substrate;
a coating mechanically bonded to the metallic substrate; and
a tempered zone between the substrate and coating, formed by heating the substrate and the coating to a temperature less than approximately 600° C.

16. The coated substrate of claim 15, wherein the coating is chromium carbide.

17. The coated substrate of claim 15, further containing a second layer of coating.

18. The coated substrate of claim 15, wherein the tempered zone is formed by heating the substrate to a temperature greater than the Martensite start temperature of the substrate.

19. The coated substrate of claim 15, wherein the substrate contains first and second zones within the substrate;
the first zone is disposed between the coating and the second zone; and
a hardness of the first zone is less than a hardness of the coating and a hardness of the second zone.

20. A coated substrate comprising:
a metallic substrate;
a cermet coating approximately 50-350 μm thick mechanically bonded to the metallic substrate; and
a tempered zone between the substrate and coating, formed by heating the substrate and the coating to a temperature less than approximately 600° C.
